(19) United States
(12) Patent Application Publication
(10) Pub. No.: US 2026/0254743 A1
(43) Pub. Date: Aug. 27, 2026

(54) IMAGE ACCELERATION SYSTEM, METHOD AND APPARATUS

(71) Applicant: CLOUD INTELLIGENCE ASSETS HOLDING (SINGAPORE) PRIVATE LIMITED, Singapore (SG)

(72) Inventors: Ao WANG, Hangzhou, Zhejiang (CN); Yida XU, Hangzhou, Zhejiang (CN); Dapeng NIE, Hangzhou, Zhejiang (CN)

(21) Appl. No.: 18/871,267

(22) PCT Filed: Jul. 26, 2023
(86) PCT No.: PCT/CN2023/109433

§ 371 Date: Dec. 3, 2024

(30) Foreign Application Priority Data
Jul. 28, 2022 (CN) 202210898260.X

(51) Int. Cl. H04L 43/10; H04L 67/104

(52) U.S. Cl. CPC H04L 43/10; H04L 67/104

(57) ABSTRACT

An image acceleration system, a method and an apparatus are provided. The system includes a P2P management apparatus and a P2P service apparatus. The P2P management apparatus deployed on a managing node side acquires system information of a plurality of agent nodes and information of a root node which is abnormal in an image service cluster through the P2P service apparatus deployed on each computing node side, selects a node from the plurality of agent nodes as an alternative node for an abnormal root node according to the system information, clears the information of the root node which is abnormal from cluster networking information, sets the alternative node in the cluster networking information as the root node, and provides updated cluster networking information to the computing node in the image service cluster; the computing node processes image data according to the updated cluster networking information.

### CROSS-REFERENCE TO RELATED APPLICATIONS

The present application is a national stage of International Application No. PCT/CN2023/109433, filed on Jul. 26, 2023, which claims priority to Chinese Patent Application No. 202210898260.X, entitled “Image Acceleration System, Method and Apparatus” and filed with the China National Intellectual Property Administration on Jul. 28, 2022. Both of the aforementioned applications are hereby incorporated by reference in their entireties.

### TECHNICAL FIELD

The present application relates to the field of cloud computing technologies and, in particular, to an image acceleration system, a method and an apparatus, and an electronic device.

### BACKGROUND

A distributed serverless computing platform is a public cloud FaaS (Function-as-a-Service) product that enables a cloud application developer to more easily run and manage a micro-service application.

The distributed serverless computing platform supports a container, provides a container image service, allows a user to deploy an image of a cloud native application, and supports image startup acceleration, becoming a secure hosting and efficient distribution platform for the cloud native application. A typical container image cold-startup acceleration manner is to reduce an overall load on a single-point image warehouse brought by a batch expansion of an application instance through on-demand image reading and P2P (peer-to-peer) distribution. A container image acceleration system acquires data from an image warehouse through a dedicated back-to-origin node (SuperNode), and uses a tree-shaped P2P network to distribute image data. Computing nodes (container hosts) in the tree-shaped P2P network may transmit data to each other, and the data can be quickly distributed to all computing nodes when the batch expansion of the application instance is performed, allowing the container to be started with a second-level delay.

However, in a process of implementing the present application, the inventor found that the above solution has at least the following problems: 1) transmission efficiency of a P2P network is affected when the dedicated back-to-origin node cannot be used due to failure or maintenance needs, and network congestion occurs in a scenario of large-scale parallel distribution of the image warehouse, resulting in long cold-startup time for the container, and large-scale and large image distribution acceleration are not supported. Specifically, due to stability and other reasons, a time period for machine recycling may occur for the back-to-origin node. For example, when the back-to-origin node is upgraded, the machine will be actively recycled. Thus, a life cycle of the back-to-origin node is not trustworthy. A current P2P networking structure cannot adapt to a change of the back-to-origin node, resulting in no alternative back-to-origin node when there is a problem with the back-to-origin node, and finally a number of back-to-origin nodes will decrease. To acquire image data, the computing node needs to go through the back-to-origin node, when the number of back-to-origin nodes decreases, data transmission efficiency will be affected. 2) The dedicated back-to-origin node exists independently from the computing node in the P2P network, so system overhead is large.

### SUMMARY

The present application provides an image acceleration system to solve the problem of high delay of an image cold-startup and high system overhead in a situation that a back-to-origin node cannot be used in a prior art. The present application further provides an image acceleration method, an apparatus, and an electronic device.

The present application provides an image acceleration system, including: a P2P management apparatus, deployed on a managing node side, and configured to: acquire system information of a plurality of agent nodes and information of a root node which is abnormal in an image service cluster, where the image service cluster is based on a P2P network structure, the root node and each agent node are configured to start an application instance in a virtual running environment according to image data, and the root node is further configured to acquire the image data from an image data source; select a node from the plurality of agent nodes as an alternative node for an abnormal root node according to the system information; clear the information of the root node which is abnormal from cluster networking information, and set the alternative node in the cluster networking information as the root node; provide updated cluster networking information to a computing node in the image service cluster;
a P2P service apparatus, deployed on a computing node side, configured to: acquire system information of the computing node, and provide the system information of the computing node to the P2P management apparatus; acquire the updated cluster networking information provided by the P2P management apparatus; process the image data according to the updated cluster networking information.

The present application provides an image acceleration method, which is applied to a managing node, including:
acquiring system information of a plurality of agent nodes and information of a root node which is abnormal in an image service cluster, where the image service cluster is based on a P2P network structure, the root node and each agent node are configured to start an application instance in a virtual running environment according to image data, and the root node is further configured to acquire the image data from an image data source;
selecting a node from the plurality of agent nodes as an alternative node for an abnormal root node according to the system information;
clearing the information of the root node which is abnormal from cluster networking information, and setting the alternative node in the cluster networking information as the root node;
providing updated cluster networking information to a computing node in the image service cluster.

In an embodiment, the selecting the node from the plurality of agent nodes as the alternative node for the abnormal root node according to the system information includes:
determining a score of the each agent node according to at least one of a memory idle ratio, a CPU idle ratio, disk usage and machine startup time of the each agent node;
determining the alternative node among the plurality of agent nodes according to an order of scores of the plurality of agent nodes.

In an embodiment, the method further includes:
acquiring information of a computing node that has rejoined the image service cluster;
setting the computing node that has rejoined the image service cluster as an agent node in the cluster networking information.

In an embodiment, the method further includes:
acquiring information of an agent node which is abnormal;
clearing the information of the agent node which is abnormal from the cluster networking information.

In an embodiment, the providing the updated cluster networking information to the computing node in the image service cluster includes:
sending, through a broadcasting manner, the updated cluster networking information to the computing node in the image service cluster.

In an embodiment, the acquiring the information of the root node which is abnormal includes:
if a root node abnormality detection condition is met, acquiring the information of the root node which is abnormal, where the root node abnormality detection condition includes but is not limited to: reaching a root node abnormality detection period.

In an embodiment, the acquiring the information of the root node which is abnormal uses at least one of following manners:
if system information of the root node meets a node abnormality condition, determining that the root node is abnormal;
if a heartbeat keep-alive with a P2P service apparatus on the root node fails, determining that the root node is abnormal;
if abnormal information sent by the root node is received, determining that the root node is abnormal.

In an embodiment, an executive entity of the method is the managing node, and the managing node includes: a P2P management apparatus, a computing node management apparatus, and an administration service apparatus;
the computing node includes: a P2P service apparatus, a computing node agent apparatus, and a container acceleration apparatus;
the system information is acquired by using a following manner:
the P2P management apparatus acquires the system information by performing a heartbeat keep-alive with the P2P service apparatus.

In an embodiment, the method further includes:
if the P2P management apparatus determines that a computing node information acquiring condition is met, acquiring, through the computing node management apparatus, the information of the computing node of the image service cluster, where the computing node information acquiring condition includes but is not limited to: reaching a node information acquiring period;
acquiring information of an available computing node by performing heartbeat keep-alive with the P2P service apparatus;
the P2P management apparatus acquiring the system information by performing the heartbeat keep-alive with the P2P service apparatus includes:
the P2P management apparatus acquires the system information by performing the heartbeat keep-alive with the P2P service apparatus of the available computing node.

The present application further provides an image acceleration method, which is applied to a computing node, including:
acquiring system information of the computing node, where the computing node belongs to an image service cluster, where the image service cluster is based on a P2P network structure;
providing the system information to a P2P management apparatus, so that if it is determined that there is a root node which is abnormal in the image service cluster, the P2P management apparatus selects, according to system information of a plurality of agent nodes in the image service cluster, a node from the plurality of agent nodes as an alternative node for an abnormal root node; clearing information of the root node which is abnormal from cluster networking information, and setting the alternative node in the cluster networking information as the root node;
acquiring updated cluster networking information provided by the P2P management apparatus;
processing image data according to the updated cluster networking information, where the root node is configured to acquire the image data from an image data source and start an application instance in a virtual running environment according to the image data, for each of the plurality of agent nodes, the agent node is configured to start the application instance in the virtual running environment according to the image data.

The present application further provides an image acceleration method, including:
acquiring system information of a plurality of agent nodes and information of a root node which is abnormal in an image service cluster, where the image service cluster is based on a P2P network structure, the root node is configured to acquire image data from an image data source and start an application instance in a virtual running environment according to the image data, for each of the plurality of agent nodes, the agent node is configured to start the application instance in the virtual running environment according to the image data;
selecting a node from the plurality of agent nodes as an alternative node for an abnormal root node according to the system information;
clearing the information of the root node which is abnormal from cluster networking information, and setting the alternative node in the cluster networking information as the root node;
processing the image data according to updated cluster networking information.

The present application further provides a container image acceleration apparatus, including:
an information acquiring unit, configured to acquire system information of a plurality of agent nodes and information of a root node which is abnormal in an image service cluster, where the image service cluster is based on a P2P network structure, the root node is configured to acquire image data from an image data source and start an application instance in a virtual running environment according to the image data, for each of the plurality of agent nodes, the agent node is configured to start the application instance in the virtual running environment according to the image data;
a root node reassignment unit, configured to select a node from the plurality of agent nodes as an alternative node for an abnormal root node according to the system information;
a networking information updating unit, configured to clear the information of the root node which is abnormal from cluster networking information, and set the alternative node in the cluster networking information as the root node;
an image data processing unit, configured to process the image data according to updated cluster networking information.

The present application further provides an electronic device, including:
a processor and a memory; the memory is configured to store programs for implementing the above methods, the electronic device is powered on and runs the programs for the methods through the processor.

The present application further provides a computer readable storage medium, which stores instructions, when the instructions are running on a computer, the computer is caused to execute the above various methods.

The present application further provides a computer program product including instructions, when the instructions are running on a computer, the computer is caused to execute the above various methods.

Compared with the prior art, the present application has following advantages:
an image acceleration system provided in an embodiment of the present application includes a P2P management apparatus that may be deployed on a managing node side of an image service cluster which is based on a P2P network structure, and further includes a P2P service apparatus that may be deployed on a computing node side in a P2P network. The P2P management apparatus is configured to acquire system information of a plurality of agent nodes and information of a root node which is abnormal in the image service cluster, where the root node and each agent node are configured to start an application instance in a virtual running environment according to image data, and the root node is further configured to acquire the image data from an image data source; select a node from the plurality of agent nodes as an alternative node for an abnormal root node according to the system information; clear the information of the root node which is abnormal from cluster networking information, and set the alternative node in the cluster networking information as the root node; provide updated cluster networking information to the computing node in the image service cluster; the P2P service apparatus is configured to acquire system information of the computing node, and provide the system information of the computing node to the P2P management apparatus; acquire the updated cluster networking information provided by the P2P management apparatus; process the image data according to the updated cluster networking information. By using this processing manner, a dynamic P2P networking structure may be supported. Even if a certain back-to-origin node (root node) goes offline for a certain reason, the P2P management apparatus (P2Pmanager) assign a new back-to-origin node from the P2P network after sensing this change, the new back-to-origin node have most of required image data, and almost seamless replacement of the back-to-origin node can be thus achieved, so that there will be a fixed number of back-to-origin nodes within a period of time; thus, data transmission efficiency can be effectively ensured when some back-to-origin nodes are unavailable, thereby supporting large-scale and large image distribution acceleration. In addition, this processing manner achieves a decentralized back-to-origin node, all back-to-origin nodes are selected as computing nodes in the P2P network, both the root node and the each agent node are P2P peer nodes in a traditional sense, no additional dedicated back-to-origin nodes need to be deployed; thus, system overhead can be effectively reduced. Furthermore, since the decentralized back-to-origin node utilizes an idle network and a hard disk resource of the computing node (container host) in the P2P network to pull an image through back-to-origin, such back-to-origin node may also start an application instance according to the image at the same time, thus, an online application will not be affected.

### BRIEF DESCRIPTION OF DRAWINGS

FIG. 1 is a schematic structural diagram of an embodiment of an image acceleration system provided by the present application.

FIG. 2 is a schematic diagram of an application scenario of an embodiment of an image acceleration system provided by the present application.

FIG. 3 is an interactive schematic diagram of an embodiment of an image acceleration system provided by the present application.

FIG. 4a is a schematic diagram of a P2P networking structure before updating of an embodiment of an image acceleration system provided by the present application.

FIG. 4b is a schematic diagram of an updated P2P networking structure of an embodiment of an image acceleration system provided by the present application.

FIG. 5 is a schematic diagram of a P2P network service apparatus of an embodiment of an image acceleration system provided by the present application.

FIG. 6 is a schematic flowchart of a managing node embodiment of an image acceleration method provided by the present application.

FIG. 7 is a schematic flowchart of a computing node embodiment of an image acceleration method provided by the present application.

FIG. 8 is a schematic flowchart of an embodiment of an image acceleration method provided by the present application.

### DESCRIPTION OF EMBODIMENTS

In the following description, many specific details are illustrated to facilitate a full understanding of the present specification. However, the present application can be implemented in many other ways different from those described herein. Those skilled in the art may make similar extensions without violating the connotation of the present application. Therefore, the present application is not limited by the specific embodiments disclosed below.

In the present application, an image acceleration system, a method and an apparatus, and an electronic device are provided. In order to explain the solution provided by the embodiments of the present application clearly, a container image cold-startup acceleration technology will be described below. Then, various solutions provided by the embodiments of the present application will be described in detail one by one in the following embodiments.

A serverless computing platform is an infrastructure that supports a user application system (such as an e-commerce platform, instant messaging software, etc.). The platform will prepare a computing resource for a user, run codes in a flexible and reliable manner, and may provide log query and performance monitoring, alarm and other functions, the user no longer need to manage a server and other infrastructures, and only need to write codes and upload them, which can achieve rapid cloud migration of an application system and Serverless architecture transformation.

For an application running based on a serverless computing platform, a container image (Image) includes packaged applications and their dependencies, as well as information about a process running at startup. The container image has better portability and a richer tool chain ecosystem than a code package, but the self-contained data that is not related to the application (such as an operating system, a command tool, and other files that are not required by the application itself that come with the container image) may easily make an image bloated. During a startup process of an application instance, the image needs to be pulled from an image warehouse. A large image inevitably increases an amount of data that needs to be downloaded and decompressed, and increases cold-startup time of the application instance. For a larger image, such as the container image with a level of more than 1GB before decompression, it will cause an image pulling delay of minute-level, which significantly slows down a cold-startup performance of the application instance. This problem becomes worse if launching is performed on a large scale. The image warehouse will directly crash due to full utilization of bandwidth or too much pressure on the server end caused by concurrent pulling of images.

In order to improve a cold-startup speed of the container image, the serverless computing platform enables an image startup acceleration function for the application whose running environment is a custom container and uses a container image service. A using principle of achieving image startup acceleration is that every time such an application is created or updated, the serverless computing platform will pull the image and store it into an accelerated image cache service inside the computing platform. After the storing is completed, most of container image read requests are intercepted in a cluster to improve a cache hit rate. There is no need to request a back-to-origin pulling, which saves bandwidth consumption of a container image service node and a network image storage node, and eliminates a performance bottleneck of pulling the image data through the network. A startup speed of a custom container image in the application will be significantly improved, a faster container image startup speed will be brought to the computing platform, thereby improving an end-to-end experience of the user. By enabling image acceleration, the image pulling can be shorten from the minute-level to second-level.

The container image acceleration system is located at an acceleration layer between image storage and the application, and supports on-demand image reading and P2P image distribution, which may reduce an overall load on a single-point image warehouse brought by a batch expansion of a computing node. A P2P image distribution network includes multiple computing nodes, which may be container hosts or virtual machine hosts. A principle of the P2P image distribution is to divide the image into many “blocks (block)”. If a certain computing node pulls this block, other nodes may pull data from this node, so as to prevent all requests from hitting the image warehouse. For example, if an application container engine Docker client is deployed on a node, and if a certain Docker client pulls this block, other Docker clients may pull data from this client.

In a prior art of the P2P image distribution (also referred as a native P2P solution), a fixed back-to-origin node is responsible for storing a relationship between the “block” and the client (computing node). A first request from client A will hit back to the back-to-origin node, and then the back-to-origin node pulls data from the image warehouse and forwards it to client A, and records a correspondence relationship between these blocks and client A. When other clients (B, C, . . . ) subsequently request these blocks, the back-to-origin node tells the clients (B, C, . . . ) that they should acquire the data from the node (client A) that already successfully performs pulling just now, so as to reduce load of the image warehouse. As illustrated by the applicant in the above background, when the back-to-origin node of this native P2P solution is unavailable, transmission efficiency of a P2P network will be affected, thus, large-scale and large image distribution acceleration are not supported. Moreover, since additionally deployed dedicated back-to-origin node exists independently from the P2P network, the system overhead is also large.

It should be noted that the image service provided by the serverless computing platform to the user may not only start the application instance according to the image data in the container, but also start the application instance according to the image data in a virtual machine. Compared with the virtual machine, features of the container are lightweight and fast to start. Compared with the virtual machine which has a dozen gigabytes of images, the container image only contains the application and a dependency library required by the application, so they may be hundreds of megabytes or even less. The following embodiments mainly take a container image startup scenario as an example for illustration, but various solutions provided by the embodiments of the present application may also be used in a virtual machine image startup scenario.

### First Embodiment

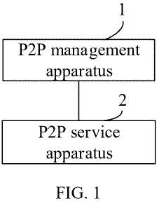

Please refer to FIG. 1, which is a schematic structural diagram of an embodiment of an image acceleration system of the present application. In the embodiment, the system includes: a P2P management apparatus 1 and a P2P service apparatus 2.

The system provided by the embodiment of the present application uses networking logic of decentralized cluster networking information (NodeList), achieves a management of P2P topology logic through cooperation of the P2P management apparatus 1 and the P2P service apparatus 2, and achieves a container image acceleration manner with reusable computing node. Specifically, in the system, a fixed dedicated back-to-origin node in a native P2P solution is removed, and a peer node in a P2P network is divided into two categories: a root node and an agent node. The agent node is responsible for starting an application instance by using a container image, the root node is not only responsible for starting the application instance by using the container image, but also responsible for a task of pulling data through back-to-origin by using an idle network and a hard disk resource of the computing node. Through the P2P management apparatus 1, when it is found that certain root nodes are about to go offline, the system may select alternative root nodes from other agent nodes according to a device operation situation of other agent nodes in the P2P network, so as to achieve a dynamic assignment of the back-to-origin node, which can ensure a fixed number of back-to-origin nodes within a period of time and thus can support large-scale and large image distribution acceleration.

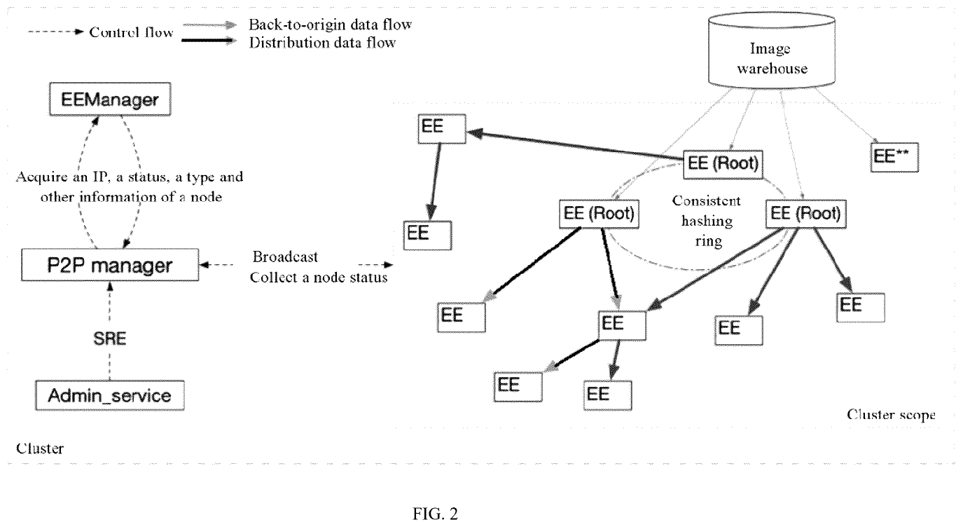

As shown in FIG. 2, in the embodiment, a serverless computing platform includes a container image server cluster, the cluster may include at least one image warehouse which may be deployed on a storage node side, a managing node (left part), a tree-shaped P2P image distribution network composed of multiple computing nodes (EE, cluster part on the right). The system utilizes a tree-shaped P2P network to distribute image data. Part of nodes in the P2P network is the root node, the root node may be used as a container host and be responsible for starting an application instance by using the container image, and may also be used as the back-to-origin node to pull an image through back-to-origin by utilizing the idle network and the hard disk resource of the node. After acquiring the image data from the image warehouse, the root node stores the image data into the P2P network, which is equivalent to providing an accelerated image cache service. Another part of the nodes in the P2P network is the agent node, which is a host of the container. The agent nodes may transmit the image data to each other. When a batch expansion of the application instance, the image data may be quickly distributed to all computing nodes (including the root node and the agent node), which can allow the container to be started with a second-level delay.

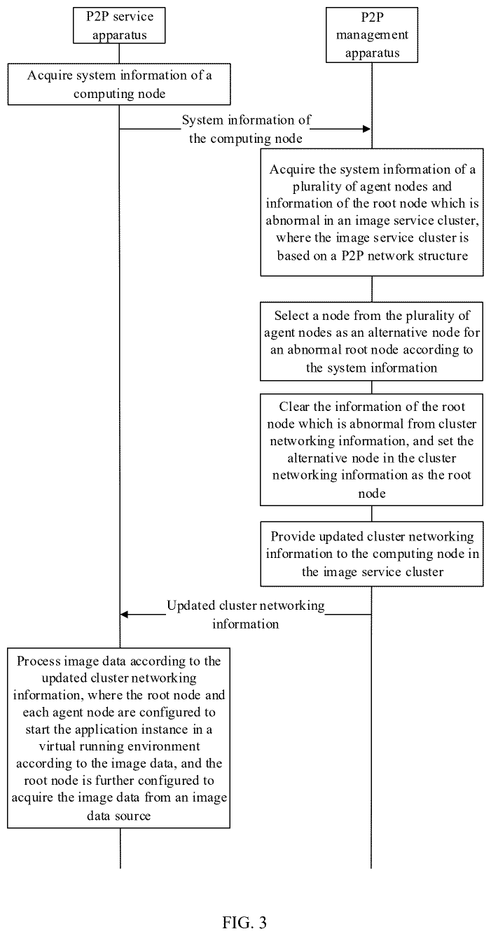

As shown in FIG. 3, the P2P management apparatus 1 is configured to: acquire system information of a plurality of agent nodes and information of a root node which is abnormal in an image service cluster, where the image service cluster is based on a P2P network structure; select a node from the plurality of agent nodes as an alternative node for an abnormal root node according to the system information; clear the information of the root node which is abnormal from cluster networking information, and set the alternative node in the cluster networking information as the root node; provide updated cluster networking information to the computing node in the image service cluster; the P2P service apparatus 2 is configured to: acquire system information of the computing node, and provide the system information of the computing node to the P2P management apparatus 1; acquire the updated cluster networking information provided by the P2P management apparatus 1; process the image data according to the updated cluster networking information. The root node and each agent node are configured to start the application instance in a virtual running environment according to the image data, and the root node is further configured to acquire the image data from an image data source.

The root node which is abnormal may be a root node which fails, or may be a root node that needs to perform system upgrading and other maintenance operations.

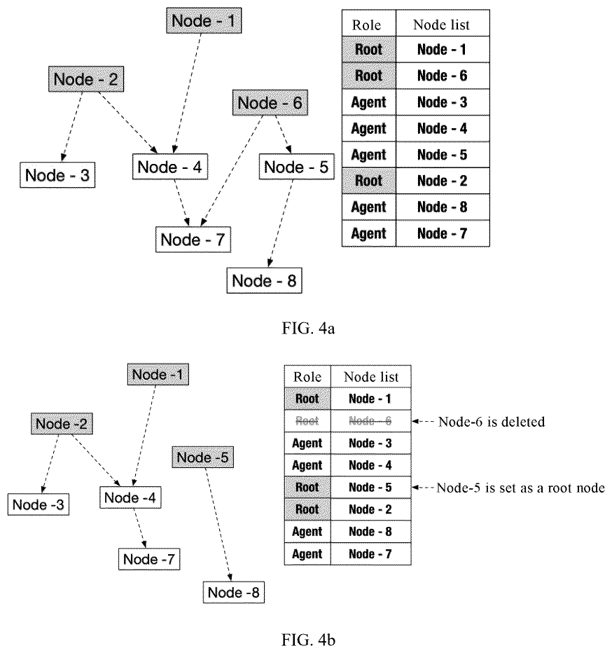

The cluster networking information includes role information of each computing node, and a role may be the root node or the agent node. As shown in FIG. 4a, the cluster networking information NodeList includes the role information of each node, where Node-1, Node-6 and Node-2 are root nodes, and Node-3, Node-4, Node-5, Node-8 and Node-7 are agent nodes. In the embodiment, the cluster networking information is a cluster dimensional root node list actively maintained by the managing node.

The present application proposes a concept of the cluster networking information (nodelist), and proposes a technical concept that by dynamically updating the cluster networking information, the computing node may perform addressing to an available root node according to the cluster networking information, and download the image data by accessing the root node. In the embodiment, through cooperation between the P2P management apparatus and the P2P service apparatus, the cluster networking information is dynamically updated, which can adapt to a more dynamic machine life period, and can automatically remove unavailable nodes. Thus, a fault tolerance probability can be effectively improved, a P2P topology logical status can be automatically operated and maintained, thereby improving a cold-startup speed of the container image.

In the embodiment, the back-to-origin node of the system is not fixed, but may dynamically change according to the device operating situation of the computing node in the P2P network. When a root node server cannot be used due to failure or maintenance needs, the P2P management apparatus 1 will decide which agent node server to replace the root node server and automatically take over a work of the root node server. As shown in FIG. 4b, when the root node Node-6 in FIG. 4a is taken offline due to upgrading, the computing node Node-5 may be assigned as the root node to replace the offline root node Node-6. At this time, the role information of the Node-6 is cleared from the cluster networking information NodeList, and Node-5 is marked as the root node. By using this processing manner, there are always enough root nodes to acquire data from the image warehouse under a high concurrency situation to ensure data transmission efficiency, thus ensuring low delay in cold-startup of the container image and allowing the container to be started with the second-level delay.

During a specific implementation, the computing node in the P2P network may periodically update the cluster networking information (NodeList configuration file) to acquire a latest Root and Agent lists in the cluster. When an image startup request reaches a certain computing node, the node will first read the cluster networking information from a local NodeList, so that the image data can be pulled from near storage when the image is started.

As shown in FIG. 2, during the specific implementation, the P2P management apparatus 1 may send updated cluster networking information to the computing node in the image service cluster through a broadcasting manner. By using this processing manner, efficiency of updating cluster networking information by each computing node can be effectively improved.

The system information includes, but is not limited to: power-up time of the computing node, usage information of a storage space, usage information of a memory space, usage information of a CPU, and a network speed.

In an example, the P2P management apparatus 2 is specifically configured to: determine a score of the each agent node according to at least one of a memory idle ratio, a CPU idle ratio, disk usage and machine startup time of the each agent node; determine the alternative node among the plurality of agent nodes according to an order of scores of the plurality of agent nodes.

During the specific implementation, the score of the node is directly proportional to the memory idle ratio, the CPU idle ratio and the disk usage on the node, and inversely proportional to the machine startup time. For example, the score may be calculated by using the following formula: score=memory idle ratio*CPU idle ratio*disk usage/machine startup time. By using this processing manner, the root node has more idle network and hard disk resource to be responsible for the task of pulling data through back-to-origin; thus, the efficiency of pulling the image through back-to-origin can be effectively improved.

In an example, the P2P management apparatus 1 may use the following manners to acquire the information of the root node which is abnormal: if a root node abnormality detection condition is met, acquire the information of the root node which is abnormal, where the root node abnormality detection condition includes but is not limited to: reaching a root node abnormality detection period. For example, detect whether there is an abnormal root node every minute. By using this processing manner, the abnormal root node may be detected regularly.

In an example, if the P2P management apparatus 1 may use the following manners to acquire the information of the root node which is abnormal: if the system information of the root node meets a node abnormality condition, determine that the root node is abnormal, where the node abnormality condition may be set according to an application requirement; if a heartbeat keep-alive with a P2P service apparatus on the root node fails, determine that the root node is abnormal; if abnormal information sent by the root node is received, determine that the root node is abnormal.

During the specific implementation, the P2P management apparatus 1 may acquire the system information by performing a heartbeat keep-alive with the P2P service apparatus.

The P2P service apparatus 2 is responsible for managing the cluster networking information NodeList of the computing node where the P2P service apparatus 2 is located. In an example, the P2P service apparatus 2 may perform an rpc communication with the P2P management apparatus 1 and periodically collect the system information on the node, where the system information includes but is not limited to power-up time, an available data disk space, an available memory space, etc. The P2P service apparatus 2 may pull the required image file from a corresponding node according to the current local NodeList configuration file.

As can be seen from FIG. 2, in an example, the managing node includes the P2P management apparatus 1 (P2P manager), and a computing node management apparatus (EEManager) and an administration service apparatus (Admin_service) are also deployed on a managing node side. EEManager and Admin_service are existing apparatuses for the managing node. EEManager is configured to acquire information of a plurality of computing nodes (EE) in the cluster, including an IP, a status, a type and other information of the computing node.

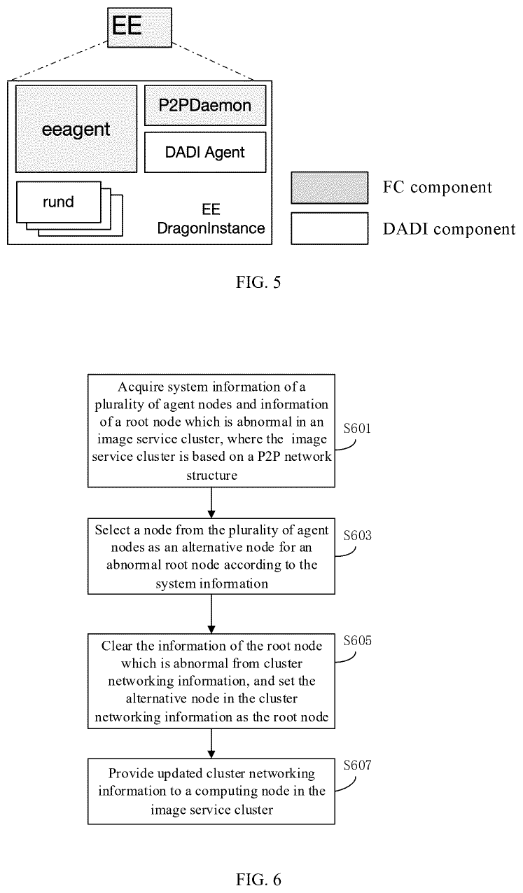

As shown in FIG. 5, each of the plurality of computing nodes (including the root node and the agent node) in the P2P network includes the P2P service apparatus 2 (P2P Daemon). A computing node agent apparatus (EEagent) and a container acceleration apparatus (DADI Agent) are also deployed on the computing node side. DADI refers to data on-demand read acceleration format based on block storage. By using this processing manner, the P2P service apparatus 2 is located on a bypass control of the computing node without changing an existing application calling link. Both the P2P management apparatus 1 and the P2P service apparatus 2 are connected to the existing container image acceleration system in a form of plug-in, so as to achieve a container image acceleration without intrusion into the computing node and the managing node of a production environment; thus, a transformation cost of the container image acceleration system can be effectively reduced.

In an example, the P2P management apparatus 1 is also configured to: if it is determined that the computing node information acquiring condition is met, acquire, through the computing node management apparatus, the information of the computing node of the image service cluster, where the computing node information acquiring condition includes but is not limited to: reaching node information acquiring period; the P2P management apparatus 1 acquires information of the available computing node by performing the heartbeat keep-alive with the P2P service apparatus 2; the P2P management apparatus 1 acquires the system information by performing the heartbeat keep-alive with the P2P service apparatus of the available computing node.

The P2P management apparatus 1 is responsible for managing a computing node machine in a P2P networking, updating latest networking information in the cluster on each node, kicking an unhealthy machine out of the networking, etc. During the specific implementation, the P2P management apparatus 1 may periodically communicate with the computing node management apparatus, acquire all computing node machines in a current cluster, and filter out machines that are serving the application. The P2P management apparatus 1 may also periodically perform the heartbeat keep-alive with the P2P service apparatus 2 on the computing node to acquire latest system information of the machine: including the life cycle of the machine, a remaining available data disk space, etc. After each collection is completed, the P2P management apparatus 1 will recalculate a networking structure according to current latest data, and assign a new root node.

In an example, the P2P management apparatus 1 is also configured to acquire the information of a computing node that has rejoined the image service cluster; and set the computing node that has rejoined the image service cluster as the agent node in the cluster networking information. The P2P management apparatus 1 may also be configured to acquire information of the agent node which is abnormal, and clear the information of the agent node which is abnormal from the cluster networking information. By using this processing manner, a P2P network structure is self-healing and may adapt to an addition and a deletion of the computing node. When an abnormal node appears, it will be removed from the networking by the P2P management apparatus 1, which may cover a situation that the life cycle of the computing node is unpredictable under a scenario of the image startup acceleration; thus, data transmission efficiency can be effectively ensured.

During the specific implementation, when an abnormality occurs in a certain computing node (such as network failure, memory/CPU and other system resources are tight, and other situations), the P2P management apparatus 1 will actively abandon this node in the networking logic after making a decision. For example, the agent node is about to be offline, and the heartbeat keep-alive between the P2P management apparatus 1 and the P2P service apparatus 2 of the node fails, the node is kicked out of the networking and broadcasted, and other nodes continue to provide a data service as usual.

For another example, if the root node is about to be offline, and the heartbeat keep-alive between the P2P management apparatus 1 and the P2P service apparatus 2 of the node fails, an updating of the NodeList will be broadcast to all available computing nodes, and a new root node will be selected, the cluster networking information may be updated through a communication between the P2P management apparatus 1 and the P2P service apparatus 2, which can ensure that the agent node can perform addressing to the new root node without causing stagnation in a data transmission. For example, when an image startup request falls on a certain node A, the node A will calculate each layer information of the image corresponding to the request, find the root node according to layer information, and then send an image acquiring request to the root node. After receiving the image acquiring request, the corresponding root node will tell the node A that its required data source is which node specifically; the node A will acquire data from the corresponding node. In a case that the image acquiring request received by the root node is a cold-startup (a first request for the image data, cache miss), the root node will read the data from the data source.

It can be seen from the above embodiment that an image acceleration system provided by an embodiment of the present application includes a P2P management apparatus that may be deployed on a managing node side of an image service cluster which is based on a P2P network structure, and further includes a P2P service apparatus that may be deployed on a computing node side in a P2P network. The P2P management apparatus is configured to: acquire system information of a plurality of agent nodes and information of a root node which is abnormal in the image service cluster, where the root node and each agent node are configured to start an application instance in a virtual running environment according to image data, and the root node is further configured to acquire the image data from an image data source; select a node from the plurality of agent nodes as an alternative node for an abnormal root node according to the system information; clear the information of the root node which is abnormal from cluster networking information, and set the alternative node in the cluster networking information as the root node; provide updated cluster networking information to a computing node in the image service cluster; the P2P service apparatus is configured to: acquire system information of the computing node, and provide the system information of the computing node to the P2P management apparatus; acquire the updated cluster networking information provided by the P2P management apparatus; process the image data according to the updated cluster networking information. By using this processing manner, a dynamic P2P networking structure may be supported. Even if a certain back-to-origin node (root node) goes offline for a certain reason, the P2P management apparatus (P2Pmanager) will assign a new back-to-origin node from the P2P network after sensing this changing, the new back-to-origin node have most of required data, and almost seamless replacement of the back-to-origin node can be achieved, so that there will be a fixed number of back-to-origin nodes within a period of time; thus, data transmission efficiency can be effectively ensured when some back-to-origin nodes are unavailable, thereby supporting large-scale and large image distribution acceleration. In addition, this processing manner achieves a decentralized back-to-origin node, all back-to-origin nodes are selected as computing nodes in the P2P network, both the root node and the each agent node are P2P peer nodes in a traditional sense, no additional dedicated back-to-origin nodes need to be deployed; thus, system overhead can be effectively reduced. Furthermore, since the decentralized back-to-origin node utilizes an idle network and a hard disk resource of the computing node (container host) in the P2P network to pull an image through back-to-origin, such back-to-origin node may also start an application instance according to the image at the same time, thus, an online application will not be affected.

### Second Embodiment

In the above embodiment, an image acceleration system is provided. Correspondingly, the present application further provides an image acceleration method. The method corresponds to the embodiment of the system described above. Since the method embodiment is basically similar to the system embodiment, the description about the method embodiment is relatively simple. For relevant details, please refer to the partial illustration of the system embodiment. The method embodiment described below is merely for illustrative purpose.

Please refer to FIG. 6, which is a schematic flowchart of an embodiment of an image acceleration method of the present application. In the embodiment, the method includes:

Step S601, acquire system information of a plurality of agent nodes and information of a root node which is abnormal in an image service cluster, where the image service cluster is based on a P2P network structure.

The root node and each agent node are configured to start an application instance in a virtual running environment according to image data, and the root node is further configured to acquire the image data from an image data source. The virtual running environment may be a container or a virtual machine.

In an example, acquiring the information of the root node which is abnormal may be implemented in the following manner: if a root node abnormality detection condition is met, acquiring the information of the root node which is abnormal, where the root node abnormality detection condition includes but is not limited to: reaching a root node abnormality detection period.

In an example, acquiring the information of the root node which is abnormal may be implemented by using at least one of the following manners: if the system information of the root node meets a node abnormality condition, determining that the root node is abnormal; if a heartbeat keep-alive with a P2P service apparatus on the root node fails, determining that the root node is abnormal; if abnormal information sent by the root node is received, determining that the root node is abnormal.

Step S603, select a node from the plurality of agent nodes as an alternative node for an abnormal root node according to the system information.

In an example, the step S603 may include the following sub-steps: determining a score of the each agent node according to at least one of a memory idle ratio, a CPU idle ratio, disk usage and machine startup time of the each agent node; determining the alternative node among the plurality of agent nodes according to an order of scores of the plurality of agent nodes.

Step S605, clear the information of the root node which is abnormal from cluster networking information, and set the alternative node in the cluster networking information as the root node.

Step S607, provide updated cluster networking information to a computing node in the image service cluster.

In an example, the step S607 may be implemented in the following manner: sending, through a broadcasting manner, the updated cluster networking information to the computing node in the image service cluster.

In an example, the method may further include the following steps: acquiring information of a computing node that has rejoined the image service cluster; setting the computing node that has rejoined as an agent node in the cluster networking information.

In an example, the method may further include the following steps: acquiring information of an agent node which is abnormal; clearing the information of the agent node which is abnormal from the cluster networking information.

In an example, an executive entity of the method is a managing node, the managing node includes: a P2P management apparatus, a computing node management apparatus, and an administration service apparatus; the computing node includes: a P2P service apparatus, a computing node agent apparatus, and a container acceleration apparatus; the system information is acquired by using the following manners: the P2P management apparatus acquires the system information by performing a heartbeat keep-alive with the P2P service apparatus.

In an example, the method may further include the following steps: if the P2P management apparatus determines that the computing node information acquiring condition is met, acquiring, through the computing node management apparatus, the information of the computing node of the image service cluster, where the computing node information acquiring condition includes but is not limited to: reaching a node information acquiring period; acquiring information of an available computing node by performing heartbeat keep-alive with the P2P service apparatus; the P2P management apparatus acquires the system information by performing the heartbeat keep-alive with the P2P service apparatus of the available computing node.

### Third Embodiment

In the above embodiment, an image acceleration method is provided. Correspondingly, the present application further provides an image acceleration apparatus. The apparatus corresponds to the embodiment of the method described above. Since the apparatus embodiment is basically similar to the method embodiment, the description about the apparatus is relatively simple. For relevant details, please refer to the partial illustration of the method embodiment. The apparatus embodiment described below is merely for illustrative purpose.

The present application further provides an image acceleration apparatus, including: an information acquiring unit, a root node reassignment unit, a networking information updating unit, and an updated data sending unit;
the information acquiring unit is configured to acquire system information of a plurality of agent nodes and information of a root node which is abnormal in an image service cluster, where the image service cluster is based on a P2P network structure, the root node is configured to acquire image data from an image data source and start an application instance in a virtual running environment according to the image data, for each of the plurality of agent nodes, the agent node is configured to start the application instance in the virtual running environment according to the image data;
the root node reassignment unit is configured to select a node from the plurality of agent nodes as an alternative node for an abnormal root node according to the system information;
the networking information updating unit is configured to clear the information of the root node which is abnormal from cluster networking information, and set the alternative node in the cluster networking information as the root node;
the updated data sending unit is configured to provide updated cluster networking information to a computing node in the image service cluster.

### Fourth Embodiment

In the above embodiment, an image acceleration system is provided. Correspondingly, the present application further provides an image acceleration method. The method corresponds to the embodiment of the system described above. Since the method embodiment is basically similar to the system embodiment, the description about the method embodiment is relatively simple. For relevant details, please refer to the partial illustration of the system embodiment. The method embodiment described below is merely for illustrative purpose.

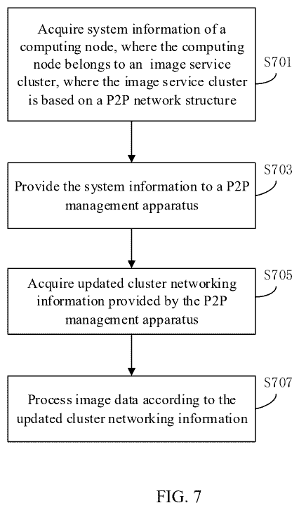

Please refer to FIG. 7, which is a schematic flowchart of an embodiment of an image acceleration method of the present application. In the embodiment, the method includes:

Step S701, acquire system information of a computing node, where the computing node belongs to an image service cluster, where the image service cluster is based on a P2P network structure.

Step S703, provide the system information to a P2P management apparatus, so that if it is determined that there is a root node which is abnormal in the image service cluster, the P2P management apparatus selects, according to system information of a plurality of agent nodes in the image service cluster, a node from the plurality of agent nodes as an alternative node for an abnormal root node; clear information of the root node which is abnormal from cluster networking information, and set the alternative node in the cluster networking information as the root node.

Step S705, acquire updated cluster networking information provided by the P2P management apparatus.

Step S707, process image data according to the updated cluster networking information.

The root node is configured to acquire the image data from an image data source and start an application instance in a virtual running environment according to the image data, for each of the plurality of agent nodes, the agent node is configured to start the application instance in the virtual running environment according to the image data.

In an example, the method may further include the following steps: acquiring abnormal information of the computing node; providing the abnormal information to the P2P management apparatus, so that after receiving the abnormal information sent by the root node, the P2P management apparatus acquires the system information of the plurality of agent nodes; after receiving the abnormal information sent by the agent node, the P2P management apparatus clears the information of the agent node from the cluster networking information.

### Fifth Embodiment

In the above embodiment, an image acceleration method is provided. Correspondingly, the present application further provides an image acceleration apparatus. The apparatus corresponds to the embodiment of the method described above. Since the apparatus embodiment is basically similar to the method embodiment, the description about the apparatus is relatively simple. For relevant details, please refer to the partial illustration of the method embodiment. The apparatus embodiment described below is merely for illustrative purpose.

The present application further provides an image acceleration apparatus, including: a system information acquiring unit, a system information sending unit, an updated information acquiring unit, and an image data processing unit;
the system information acquiring unit is configured to acquire system information of a computing node, where the computing node belongs to an image service cluster which is based on a P2P network structure;
the system information sending unit is configured to provide the system information to a P2P management apparatus, so that if it is determined that there is a root node which is abnormal in the image service cluster, the P2P management apparatus selects, according to system information of a plurality of agent nodes in the image service cluster, a node from the plurality of agent nodes as an alternative node for an abnormal root node according to the system information of the plurality of agent nodes in the image service cluster; clear information of the root node which is abnormal from cluster networking information, and set the alternative node in the cluster networking information as the root node;
the updated information acquiring unit is configured to acquire updated cluster networking information provided by the P2P management apparatus;
the image data processing unit is configured to process image data according to the updated cluster networking information, where the root node is configured to acquire the image data from an image data source and start an application instance in a virtual running environment according to the image data, for each of the plurality of agent nodes, the agent node is configured to start the application instance in the virtual running environment according to the image data.

### Sixth Embodiment

In the above embodiment, an image acceleration system is provided. Correspondingly, the present application further provides an image acceleration method. The method corresponds to the embodiment of the system described above. Since the method embodiment is basically similar to the system embodiment, the description about the method embodiment is relatively simple. For relevant details, please refer to the partial illustration of the system embodiment. The method embodiment described below is merely for illustrative purpose.

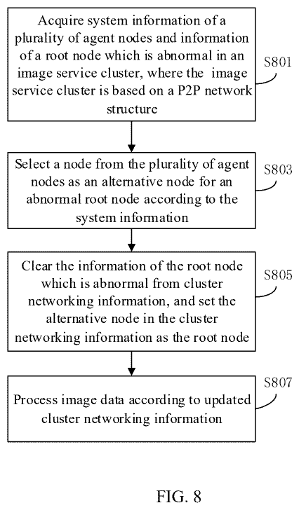

Please refer to FIG. 8, which is a schematic flowchart of an embodiment of an image acceleration method of the present application. In the embodiment, the method includes:

Step S801, acquire system information of a plurality of agent nodes and information of a root node which is abnormal in an image service cluster, where the image service cluster is based on a P2P network structure.

The root node is configured to acquire image data from an image data source and start an application instance in a virtual running environment according to the image data, for each of the plurality of agent nodes, the agent node is configured to start the application instance in the virtual running environment according to the image data.

Step S803, select a node from the plurality of agent nodes as an alternative node for an abnormal root node according to the system information.

Step S805, clear the information of the root node which is abnormal from cluster networking information, and set the alternative node in the cluster networking information as the root node.

Step S807, process the image data according to updated cluster networking information.

### Seventh Embodiment

In the above embodiment, an image acceleration method is provided. Correspondingly, the present application further provides an image acceleration apparatus. The apparatus corresponds to the embodiment of the method described above. Since the apparatus embodiment is basically similar to the method embodiment, the description about the apparatus is relatively simple. For relevant details, please refer to the partial illustration of the method embodiment. The apparatus embodiment described below is merely for illustrative purpose.

The present application further provides an image acceleration apparatus, including: an information acquiring unit, a root node reassignment unit, a networking information updating unit, and an image data processing unit;
the information acquiring unit is configured to acquire system information of a plurality of agent nodes and information of a root node which is abnormal in an image service cluster, where the image service cluster is based on a P2P network structure, the root node is configured to acquire image data from an image data source and start an application instance in a virtual running environment according to the image data, for each of the plurality of agent nodes, the agent node is configured to start the application instance in the virtual running environment according to the image data;
the root node reassignment unit is configured to select a node from the plurality of agent nodes as an alternative node for an abnormal root node according to the system information;
the networking information updating unit is configured to clear the information of the root node which is abnormal from cluster networking information, and set the alternative node in the cluster networking information as the root node;
the image data processing unit is configured to process the image data according to updated cluster networking information.

### Eighth embodiment

In the above embodiment, an image acceleration method is provided. Correspondingly, the present application further provides an electronic device. The device corresponds to the embodiment of the method described above. Since the device embodiment is basically similar to the method embodiment, the description about the device is relatively simple. For relevant details, please refer to the partial illustration of the method embodiment. The device embodiment described below is merely for illustrative purpose.

The present application further provides an electronic device, including: a processor and a memory. The memory is configured to store programs for implementing the image acceleration method provided by the above method embodiments, the electronic device is powered on and runs the programs for the method through the processor.

Although the present application is disclosed as above with preferred embodiments, the preferred embodiments are not intended to limit the present application. Any person skilled in the art may make possible changes and modifications without departing from the spirit and scope of the present application. Therefore, the protection scope of the present application shall be subject to the scope defined by the claims of the present application.

In a typical configuration, a computing device includes one or more processors (CPUs), an input/output interface, a network interface, and a memory.

The memory may include non-permanent storage in a computer readable medium, a random access memory (RAM), and/or a non-volatile memory and other forms, such as, a read-only memory (ROM) or a flash memory (flash RAM). The memory is an example of the computer readable medium.
1. The computer readable medium includes permanent and non-permanent, removable and non-removable media that may be used to store information by any method or technology. The information may be computer readable instructions, data structures, modules of programs, or other data. An example of the computer storage medium includes, but is not limited to, a phase change memory (PRAM), a static random access memory (SRAM), a dynamic random access memory (DRAM), other types of random access memory (RAM), the read-only memory (ROM), an electrically erasable programmable read-only memory (EEPROM), the flash memory or other memory technologies, a compact disc read-only memory (CD-ROM), a digital versatile disc (DVD) or other optical storage, a magnetic tape cassette, a tape magnetic disk storage or other magnetic storage devices or any other non-transmission medium, and may be used to store information that may be accessed by a computing device. As defined in the context, the computer readable medium does not include a non-transitory computer readable medium (transitory media), such as a modulated data signal and a carrier.
2. Those skilled in the art should understand that the embodiments of the present application may be provided as a method, a system or a computer program product. Thus, the present application may use the form of an entirely hardware embodiment, an entirely software embodiment, or an embodiment combining software and hardware aspects. Furthermore, the present application may use the form of a computer program product implemented on one or more computer usable storage media (including, but not limited to, disk storage, a CD-ROM, optical storage, etc.) including computer usable program codes.

1. An image acceleration system, comprising:
a P2P management apparatus, deployed on a managing node side, and configured to:
acquire system information of a plurality of agent nodes and information of a root node which is abnormal in an image service cluster, wherein the image service cluster is based on a P2P network structure, the root node and each agent node are configured to start an application instance in a virtual running environment according to image data, and the root node is further configured to acquire the image data from an image data source;
select a node from the plurality of agent nodes as an alternative node for an abnormal root node according to the system information;
clear the information of the root node which is abnormal from cluster networking information, and set the alternative node in the cluster networking information as the root node;
provide updated cluster networking information to a computing node in the image service cluster;
a P2P service apparatus, deployed on a computing node side, and configured to:
acquire system information of the computing node, and provide the system information of the computing node to the P2P management apparatus;
acquire the updated cluster networking information provided by the P2P management apparatus;
process the image data according to the updated cluster networking information.

2. An image acceleration method, which is applied to a managing node, comprising:
acquiring system information of a plurality of agent nodes and information of a root node which is abnormal in an image service cluster, wherein the image service cluster is based on a P2P network structure, the root node and each agent node are configured to start an application instance in a virtual running environment according to image data, and the root node is further configured to acquire the image data from an image data source;
selecting a node from the plurality of agent nodes as an alternative node for an abnormal root node according to the system information;
clearing the information of the root node which is abnormal from cluster networking information, and setting the alternative node in the cluster networking information as the root node;
providing updated cluster networking information to a computing node in the image service cluster.

3. The method according to claim 2, wherein the selecting the node from the plurality of agent nodes as the alternative node for the abnormal root node according to the system information comprises:
determining a score of the each agent node according to at least one of a memory idle ratio, a CPU idle ratio, disk usage and machine startup time of the each agent node;
determining the alternative node among the plurality of agent nodes according to an order of scores of the plurality of agent nodes.

4. The method according to claim 2, further comprising:
acquiring information of a computing node that has rejoined the image service cluster;
setting the computing node that has rejoined the image service cluster as an agent node in the cluster networking information.

5. The method according to claim 2, further comprising:
acquiring information of an agent node which is abnormal;
clearing the information of the agent node which is abnormal from the cluster networking information.

6. The method according to claim 2, wherein the providing the updated cluster networking information to the computing node in the image service cluster comprises:
sending, through a broadcasting manner, the updated cluster networking information to the computing node in the image service cluster.

7. The method according to claim 2, wherein the acquiring the information of the root node which is abnormal comprises:
if a root node abnormality detection condition is met, acquiring the information of the root node which is abnormal, wherein the root node abnormality detection condition comprises but is not limited to: reaching a root node abnormality detection period.

8. The method according to claim 2, wherein the acquiring the information of the root node which is abnormal uses at least one of following manners:
if system information of the root node meets a node abnormality condition, determining that the root node is abnormal;
if a heartbeat keep-alive with a P2P service apparatus on the root node fails, determining that the root node is abnormal;
if abnormal information sent by the root node is received, determining that the root node is abnormal.

9. The method according to claim 2, wherein,
an executive entity of the method is the managing node, and the managing node comprises: a P2P management apparatus, a computing node management apparatus, and an administration service apparatus;
the computing node comprises: a P2P service apparatus, a computing node agent apparatus, and a container acceleration apparatus;
the system information is acquired by using a following manner:
the P2P management apparatus acquires the system information by performing a heartbeat keep-alive with the P2P service apparatus.

10. The method according to claim 9, further comprising:
if the P2P management apparatus determines that a computing node information acquiring condition is met, acquiring, through the computing node management apparatus, the information of the computing node of the image service cluster, wherein the computing node information acquiring condition comprises but is not limited to: reaching a node information acquiring period;
acquiring information of an available computing node by performing heartbeat keep-alive with the P2P service apparatus;
the P2P management apparatus acquiring the system information by performing the heartbeat keep-alive with the P2P service apparatus comprises:
the P2P management apparatus acquires the system information by performing the heartbeat keep-alive with the P2P service apparatus of the available computing node.

11. An image acceleration method, which is applied to a computing node, comprising:
acquiring system information of the computing node, wherein the computing node belongs to an image service cluster, wherein the image service cluster is based on a P2P network structure;
providing the system information to a P2P management apparatus, so that if it is determined that there is a root node which is abnormal in the image service cluster, the P2P management apparatus selects, according to system information of a plurality of agent nodes in the image service cluster, a node from the plurality of agent nodes as an alternative node for an abnormal root node; clearing information of the root node which is abnormal from cluster networking information, and setting the alternative node in the cluster networking information as the root node;
acquiring updated cluster networking information provided by the P2P management apparatus;
processing image data according to the updated cluster networking information, wherein the root node is configured to acquire the image data from an image data source and start an application instance in a virtual running environment according to the image data, for each of the plurality of agent nodes, the agent node is configured to start the application instance in the virtual running environment according to the image data.

12-13. (canceled)

14. An electronic device, comprising:
a processor and a memory;
wherein the memory is configured to store programs for implementing the method according to claim 2, and the electronic device is powered on and runs the programs for the method through the processor.

15. The electronic device according to claim 14, wherein the processor is configured to:
determine a score of the each agent node according to at least one of a memory idle ratio, a CPU idle ratio, disk usage and machine startup time of the each agent node;
determine the alternative node among the plurality of agent nodes according to an order of scores of the plurality of agent nodes.

16. The electronic device according to claim 14, wherein the processor is configured to:
acquire information of a computing node that has rejoined the image service cluster;
set the computing node that has rejoined the image service cluster as an agent node in the cluster networking information.

17. The electronic device according to claim 14, wherein the processor is configured to:
acquire information of an agent node which is abnormal;
clear the information of the agent node which is abnormal from the cluster networking information.

18. The electronic device according to claim 14, wherein the processor is configured to:
send, through a broadcasting manner, the updated cluster networking information to the computing node in the image service cluster.

19. The electronic device according to claim 14, wherein the processor uses at least one of following manners to acquire the information of the root node which is abnormal:
if system information of the root node meets a node abnormality condition, determining that the root node is abnormal;
if a heartbeat keep-alive with a P2P service apparatus on the root node fails, determining that the root node is abnormal;
if abnormal information sent by the root node is received, determining that the root node is abnormal.

20. An electronic device, comprising:
a processor and a memory;
wherein the memory is configured to store programs for implementing the method according to claim 11, and the electronic device is powered on and runs the programs for the method through the processor.

21. A non-transitory computer readable storage medium, having instructions stored thereon, wherein when the instructions are running on a computer, the computer is caused to execute the method according to claim 2.

22. A non-transitory computer readable storage medium, having instructions stored thereon, wherein when the instructions are running on a computer, the computer is caused to execute the method according to claim 11.
